(19) United States
(12) Patent Application Publication
(10) Pub. No.: US 2023/0222924 A1
(43) Pub. Date: Jul. 13, 2023

(54) Slot Allocation of Vertiport Resources

(71) Applicant: Aurora Fight Sciences Corporation, a subsidiary of the Boeing Company, Manassas, VA (US)

(72) Inventors: Zarrin Chua, Boston, MA (US); Alfredo Giuliano, Boston, MA (US); Francisco A. Navarro Félix, Luzern (CH); Manuela Sauer, Luzern (CH); Martin Kearney-Fischer, Boston, MA (US)

(21) Appl. No.: 17/647,495

(22) Filed: Jan. 10, 2022

(51) Int. Cl. G08G 5/00

(52) U.S. Cl. CPC G08G 5/003; G08G 5/0026

(57) ABSTRACT

A method, apparatus, system, and computer program product for managing vertiport resources. A capacity for handling air traffic at a vertiport is determined. An allocation of arrival slots, departure slots, and service slots for the air traffic using the vertiport is managed based on the capacity determined for the vertiport.

### BACKGROUND INFORMATION

### 1. Field

The present disclosure relates generally to aircraft and in particular, to managing vertiport resources used by aircraft.

### 2. Background

With increasing congestion of roadways in urban areas, other avenues of transportation such as mass transit have become more widely used. Rideshare has also increased in use. Rideshare allows a user to request a vehicle to take the user to a destination. This type of on-demand transportation reduces frustrations with driving in traffic but is still subject to commute times that are affected by the amount of road traffic congestion.

Another type of transportation involves passenger air vehicles (PAVs). A passenger air vehicle (PAV) is a type of aircraft that can be used to provide on-demand transportation in urban areas. A passenger air vehicle can seat and provide a comfortable and reliable ride for the passenger and can also be used to transport goods or other items.

A passenger air vehicle can be a piloted passenger air vehicle or can be an autonomous passenger air vehicle that provides for fully autonomous flight from takeoff to landing without needing a pilot. A passenger air vehicle can take the form of an electrical vertical takeoff and landing (eVTOL) aircraft for use in transporting passengers. An electric power system can provide cleaner and quieter transportation. Passenger air vehicles can be used for urban commutes that can be, for example, 50 miles or more.

The flight of a passenger air vehicle from an origination location to a destination location is also referred to as a mission. A vertiport is located near both the origination location and the destination location. A vertiport is a location at which the passenger air vehicle can take off and land using vertical takeoff and landing capabilities.

When operating unmanned passenger air vehicles in urban areas, an air traffic management system is used to approve and manage missions performed by passenger air vehicles. For example, a particular route for a passenger air vehicle can be approved through an air traffic management system. Additionally, a route or destination can be changed by the air traffic management system because of various events or environmental changes occurring during a flight of the passenger air vehicle.

The selection of vertiports and routes takes into consideration the availability of vertiport resources when approving and managing missions performed by passenger air vehicle. For example, the mission planning can take into account the availability of final approach and takeoff areas at a vertiport available at different time periods.

Managing the operation of passenger air vehicles can be more challenging and time-consuming than desired in providing services to transport passengers, cargo, or other items from an origination vertiport or to a destination vertiport.

### SUMMARY

An embodiment of the present disclosure provides a method for managing vertiport resources. A capacity for handling air traffic at a vertiport is determined. An allocation of arrival slots and departure slots for the air traffic using the vertiport is managed based on the capacity determined for the vertiport.

Another embodiment of the present disclosure provides a method for managing vertiport resources. A computer system determines occupancy times for a set of final approach and take off areas at a vertiport. The computer system determines an allocation of arrival slots and departure slots available for use based on the occupancy times determined for the set of final approach and take off areas at the vertiport to form a capacity for handling air traffic at the vertiport. The computer system manages an allocation of the arrival slots and the departure slots for the air traffic using the vertiport based on an availability of the final approach and take off areas at the vertiport.

Still another embodiment of the present disclosure provides a vertiport management system comprising a computer system and a vertiport manager in the computer system. The vertiport manager operates to determine a capacity for handling air traffic at a vertiport and manage an allocation of arrival slots, departure slots, and service slots for the air traffic using the vertiport based on the capacity determined for the vertiport.

Yet another embodiment of the present disclosure provides a vertiport management system comprising a computer system and a vertiport manager in the computer system. The vertiport manager operates to determine occupancy times for a set of final approach and take off areas and a set of gates at a vertiport; determine an allocation of arrival slots, departure slots, and service slots available for use based on the occupancy times determined for the set of final approach and take off areas and the set of gates at the vertiport to form a capacity for handling air traffic at the vertiport; and manage an allocation of the arrival slots, the departure slots, and the service slots for the air traffic using the vertiport based on an availability of final approach and take off areas and gates at the vertiport.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative examples are set forth in the appended claims. The illustrative examples, however, as well as a preferred mode of use, further objectives and features thereof, will best be understood by reference to the following detailed description of an illustrative example of the present disclosure when read in conjunction with the accompanying drawings, wherein:

FIG. 1 is a pictorial illustration of an air vehicle management environment in accordance with an illustrative example;

FIG. 2 is an illustration of a block diagram of an air vehicle management environment in accordance with an illustrative example;

FIG. 3 is an illustration of an arrival slot in accordance with an illustrative example;

FIG. 4 is an illustration of a departure slot in accordance with an illustrative example;

FIG. 5 is an illustration of a service slot in accordance with an illustrative example;

FIG. 6 is an illustration of slots allocated for vertiports in accordance with an illustrative example;

FIG. 7 is an illustration of slots including decimated slots in accordance with an illustrative example;

FIG. 8 is an illustration of a flowchart of a process for managing vertiport resources in accordance with an illustrative example;

FIG. 9 is an illustration of a flowchart of a process for determining capacity at a vertiport in accordance with an illustrative example;

FIG. 10 is an illustration of a flowchart of a process for determining capacity at a vertiport in accordance with an illustrative example;

FIG. 11 is an illustration of a flowchart of a process for determining capacity at a vertiport in accordance with an illustrative example;

FIG. 12 is an illustration of a flowchart of a process for determining the arrival slots, the departure slots, and the service slots available for use in accordance with an illustrative example;

FIG. 13 is an illustration of a flowchart of a process for determining the arrival slots, the departure slots, and the service slots available for use in accordance with an illustrative example;

FIG. 14 is an illustration of a flowchart of a process for managing the allocation of the arrival slots, the departure slots, and the service slots in accordance with an illustrative example;

FIG. 15 is an illustration of a flowchart of a process for managing the allocation of the arrival slots, the departure slots, and the service slots in accordance with an illustrative example;

FIG. 16 is an illustration of a flowchart of a process for managing the allocation of the arrival slots, the departure slots, and the service slots in accordance with an illustrative example;

FIG. 17 is an illustration of a flowchart of a process for managing the allocation of the arrival slots, the departure slots, and the service slots in accordance with an illustrative example;

FIG. 18 is an illustration of a flowchart of a process for managing vertiport resources in accordance with an illustrative example;

FIG. 19, an illustration of a flowchart of process for determining occupancy time is depicted in accordance with an illustrative example; and

FIG. 20 is an illustration of a block diagram of a data processing system in accordance with an illustrative example.

### DETAILED DESCRIPTION

The illustrative examples recognize and take into account one or more different considerations. For example, the illustrative examples recognize and take into account that current strategic planning of departure slots is performed for airports in a network to ensure a balance between capacity and demand in air transportation operations.

The illustrative examples recognize and take into account that network simulations can be performed to forecast the flow of arriving traffic at airports in the network over time. The illustrative examples recognize and take into account that this forecasting allows determining whether the flow exceeds the declared airport capacity. The illustrative examples recognize and take into account that when saturation situations occur in a forecast, scheduled departure times of operations can be modified to flatten the flow of arriving traffic, preventing a saturation situation. The illustrative examples also recognize and take into account that airport capacity can be monitored real time and departure slots can be managed when congestion or capacity reduction occurs dynamically, which can result in departure delays.

The illustrative examples recognize and take into account that the current techniques for balancing capacity and demand at airports only manage departure slots for departure in strategic timeframes such as mission planning. The illustrative examples recognize and take into account that the management of arrival times, taxi movements, and gate allocations is deferred to tactical timeframes such as during mission execution. The illustrative examples recognize and take into account that the extension of slot management to arrival slots or gate slots is not performed in strategic managing of air traffic because of the low fidelity in the predicting of aircraft trajectories for current airport operations at airports.

The illustrative examples recognize and take into account that these types of management techniques used with traditional airports do not apply well to traffic by air vehicles using vertiports. The illustrative examples also recognize and take into account that with vertical takeoff and landing (VTOL) aircraft and relatively short routes, higher pace operations can occur, and higher traffic densities can be present as compared to traditional airports.

The illustrative examples recognize and take into account that incoming and outgoing flows of air traffic at a vertiport can be continuously balanced over time because a vertiport operating at near maximum capacity has very limited or no ability to accumulate aircraft depending on the number of parking areas, which are also referred to as gates.

The illustrative examples recognize and take into account that the capacity of a vertiport can be characterized by the maximum number of landing, turnaround, and takeoff operations that can be performed per hour with a desired level of safety at the vertiport. The illustrative examples recognize and take into account that this capacity can be determined based on the number of final approach and take off (FATO) areas and gates available.

Thus, the illustrative examples provide a method, apparatus, system, and computer program product for managing vertiport resources. These vertiport resources can include arrival slots and departure slots for final approach and take off (FATO) areas. These slots can be used to determine the sequence of available scheduled landing times (SLDTs) and scheduled takeoff times (STOTs). These times can be used in mission planning for flights that use final approach and take off (FATO) areas at vertiports. Additionally, service slots can be used for resources used for surface operations. The service slots can be for resources selected from at least one of a parking area, a gate, a taxiway, or other suitable resources. The service slot can be for a final approach and take off area when a gate or other separate parking area is not present at the vertiport. In other words, the final approach and take off area can also function as a parking area.

As used herein, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

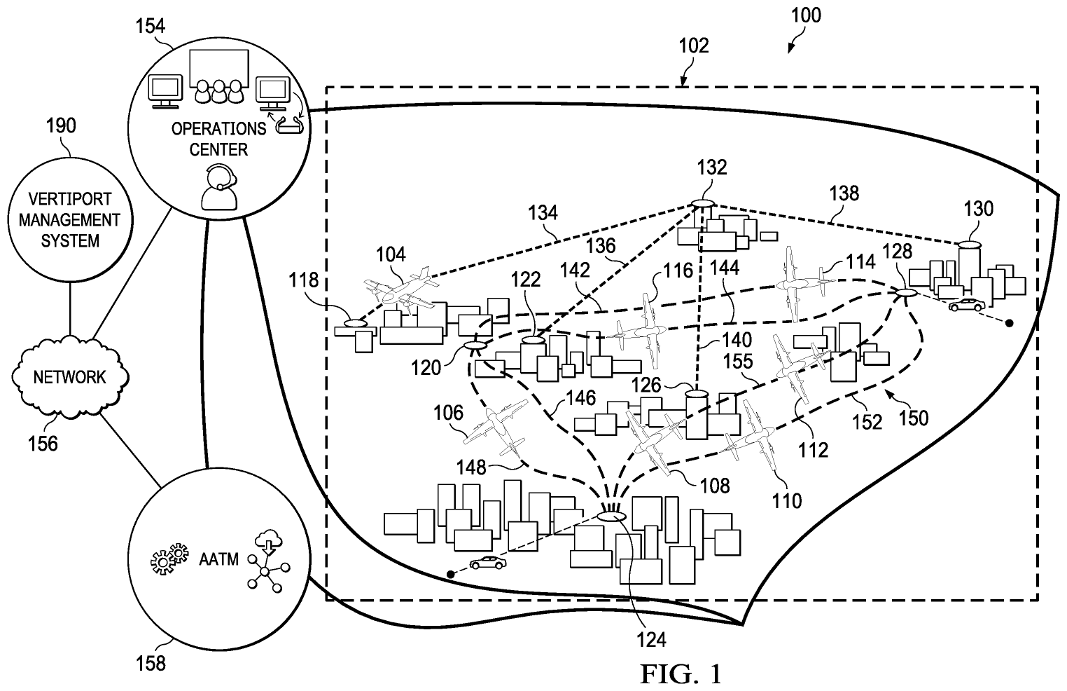

With reference now to the figures and, in particular, with reference to FIG. 1, a pictorial illustration of an air vehicle management environment is depicted in accordance with an illustrative example. As depicted, air vehicle management environment 100 is an environment in which autonomous air vehicles in the form of passenger air vehicles (PAVs) can be managed to move at least one of passengers, goods, cargo, or other objects from an origination location to destination locations in urban area 102. In this illustrative example, urban area 102 can include at least one of a city, a town, a suburb, a metropolitan area, or some other area that includes or encompasses one or more populated areas.

As depicted, passenger air vehicles servicing urban area 102 comprise passenger air vehicle 104, passenger air vehicle 106, passenger air vehicle 108, passenger air vehicle 110, passenger air vehicle 112, passenger air vehicle 114, and passenger air vehicle 116. In this illustrative example, the passenger air vehicles can be electrical vertical takeoff and landing (eVTOL) aircraft or air taxis. These types of vehicles can provide on-demand transportation in a manner that reduces (e.g., minimizes) commutes for passengers that cab be caused by road congestion and urbanization of populated areas. These passenger air vehicles can operate to provide on-demand aviation services to move the passengers from one location to another location.

In this illustrative example, the passenger air vehicles can fly along routes between different vertiports. In this illustrative example, vertiports are on locations with structures for aircraft to land and take off vertically. As depicted, the vertiports include vertiport 118, vertiport 120, vertiport 122, vertiport 124, vertiport 126, vertiport 128, vertiport 130, and vertiport 132.

The vertiports in this example can be located in many different locations such as a ground location, on top of a building, or in some other suitable location that is desirable for commuting or transportation of objects. For example, vertiport 118, vertiport 122, vertiport 126, vertiport 130, and vertiport 132 are located on buildings while vertiport 120, vertiport 124, and vertiport 128 are located at ground locations.

As depicted, the passenger air vehicles can fly on the different routes to move passengers, cargo, or both between the vertiports within urban area 102. In this illustrative example, these routes include route 134, route 136, route 138, and route 140, which are routes between buildings. The routes also include routes between ground locations. These routes include route 142, route 144, route 146, route 148, route 150, route 152, and route 155.

As depicted, the operation of the passenger air vehicles can be controlled by operations center 154. In this illustrative example, operations center 154 includes computers, communications equipment, navigation equipment, air traffic surveillance equipment, networks, and other suitable hardware that operate to manage missions for passenger air vehicles in urban area 102. Operations center 154 can be in a single location or can be distributed through multiple locations in which the different computers at those locations are connected to each other by network 156.

In this illustrative example, operations center 154 can perform various operations selected from at least one of mission planning and optimization, mission validation, route authorization, mission monitoring, or other suitable functions. For example, operations center 154 can receive requests for use of the passenger air vehicles from passengers. In processing these requests, operations center 154 can plan missions to transport from passengers between vertiports. In this illustrative example, the vertiports are in communication with operations center 154. These vertiports can be in direct communication with operations center 154 or can communicate with operations center 154 through automated aircraft traffic management 158.

In this depicted example, network 156 represents a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. In other illustrative examples, network 156 can be implemented using a number of different types of networks. For example, network 156 can be comprised of at least one of the Internet, an intranet, a local area network (LAN), a metropolitan area network (MAN), or a wide area network (WAN).

As used herein, a “number of,” when used with reference to items, means one or more items. For example, a “number of different types of networks” is one or more different types of networks.

As part of mission planning, operations center 154 can request authorization to fly missions along various routes. These requests can be sent to automated aircraft traffic management (AATM) system 158 via network 156. In this illustrative example, automated aircraft system traffic management 158 is a traffic management system for uncontrolled operations of passenger air vehicles that are separate from and complementary to the legacy air traffic management (ATM) system for the Federal Aviation Authority (FAA).

Further, operations center 154 can also communicate with at least one of the passenger air vehicles or vertiports. These components are also connected to network 156. For example, the passenger air vehicles can be connected to network 156 using wireless connections. In this manner, the passenger air vehicles can communicate with each other, vertiports, operations center 154, or some combination thereof. As another example, the passenger air vehicles can communicate with each other directly using vehicle to vehicle (V2V) communications while using frequency ranges such as 5.855 GHz to 5.905 GHz and 5.770 GHz to 5.850 GHz or other frequency ranges that may be made available.

Illustration of air vehicle management environment 100 in FIG. 1 is provided as an example of one implementation for this type of environment and is not meant to limit the manner in which air vehicle management environment 100 can be implemented in other illustrative examples. For example, in other illustrative examples, routes may be present between ground locations and buildings. In another illustrative example, the passenger air vehicles may include air vehicles with combustion propulsion systems in addition to or in place of using electric propulsion systems. In yet another illustrative example, one or more routes can connect urban area 102 to one or more urban areas in air vehicle management environment 100. In yet another example, operations center 154 can also manage missions for other urban areas in addition to or in place of urban area 102. In other illustrative examples, any type of air traffic management system can be used in addition to or in place of automated aircraft system traffic management 158. As another example, other types of air vehicles or aircraft in addition to or in place of passenger air vehicles can be managed within air vehicle management environment 100.

As depicted, vertiport management system 190 is connected to network 156. This connection enables vertiport management system 190 communicate with at least one of vertiport 118, vertiport 120, vertiport 122, vertiport 124, vertiport 126, vertiport 128, vertiport 130, or vertiport 132.

In this illustrative example, vertiport management system 190 operates to manage vertiport resources at one or more of these vertiports. For example, vertiport management system 190 can manage vertiport resources such as a final approach and take off (FATO) area, a gate, or other suitable resources.

Vertiport management system 190 can manage these resources using time management processes for increasing the usage of these resources. For example, vertiport management system 190 can manage the allocation of at least one of arrival slots or departure slots in a manner that increases the desired usage of vertiport resources. Further, vertiport management system 190 can provide a centralized solution for managing vertiport resources in multiple vertiports. As a result, vertiports managed by vertiport management system 190 can operate with a desired level of safety at higher capacities in which dynamic demand occurs as compared to current techniques of the vertiport resource management.

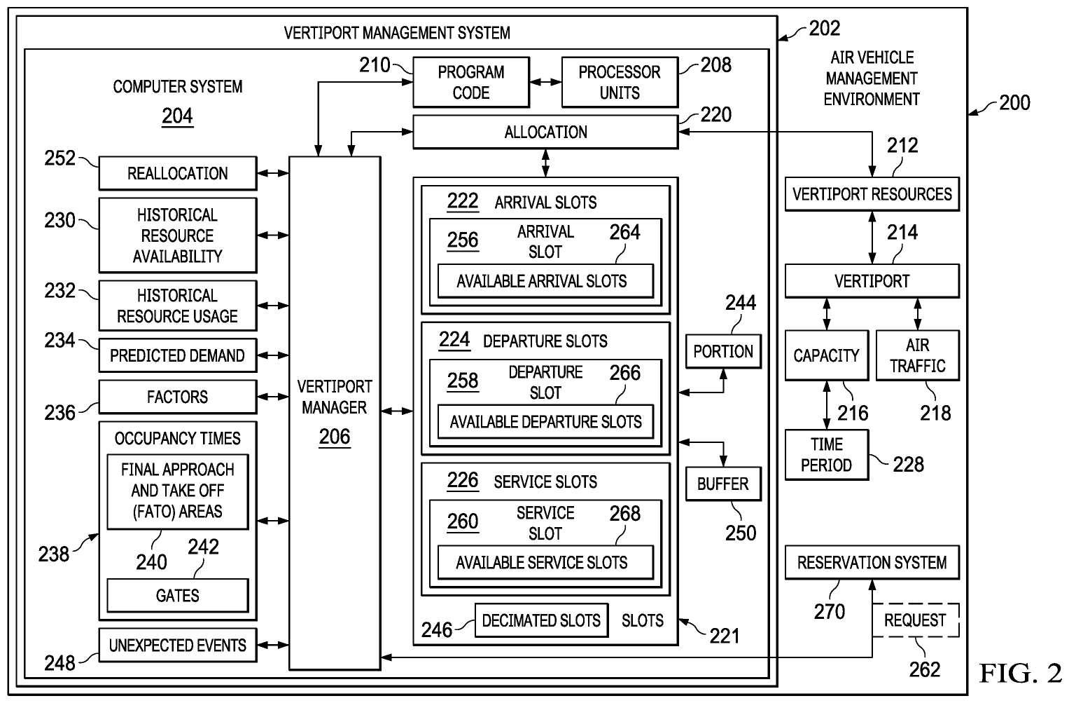

Turning next to FIG. 2, an illustration of a block diagram of an air vehicle management environment is depicted in accordance with an illustrative example. Air vehicle management environment 100 is an example of one implementation for air vehicle management environment 200 shown in block form in FIG. 2.

In this illustrative example, vertiport management system 202 in air vehicle management environment 200 can operate to manage vertiport resources 212. Vertiport management system 202 comprises a number of different components. As depicted, vertiport management system 202 comprises computer system 204 and vertiport manager 206.

Vertiport manager 206 can be implemented in software, hardware, firmware or a combination thereof. When software is used, the operations performed by vertiport manager 206 can be implemented in program code configured to run on hardware, such as a processor unit. When firmware is used, the operations performed by vertiport manager 206 can be implemented in program code and data and stored in persistent memory to run on a processor unit. When hardware is employed, the hardware can include circuits that operate to perform the operations in vertiport manager 206.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes a number of processor units 208 that are capable of executing program code 210 implementing processes in the illustrative examples. As used herein a processor unit in the number of processor units 208 is a hardware device and is comprised of hardware circuits such as those on an integrated circuit that respond and process instructions and program code that operate a computer.

When a number of processor units 208 execute program code 210 for a process, the number of processor units 208 is one or more processor units that can be on the same computer or on different computers. In other words, the process can be distributed between processor units on the same or different computers in a computer system. Further, the number of processor units 208 can be of the same type or different type of processor units. For example, a number of processor units can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, vertiport manager 206 manages vertiport resources 212 at vertiport 214. Vertiport resources 212 are resources used to handle air traffic 218 using vertiport 214. Vertiport resources 212 can be, for example, a gate, a final approach can take off (FATO) area, a hanger, a service area, or other suitable resource. In this illustrative example, air traffic 218 comprises vertical takeoff and landing (VTOL) aircraft. This type of aircraft can include, for example, helicopters, aircraft, cycle copters, and fixed wing aircraft. These aircraft can be electric or hybrid electric vertical takeoff and landing aircraft.

Vertiport manager 206 can operate to determine capacity 216 for handling air traffic 218 at vertiport 214. In this example, capacity 216 is the capacity of vertiport 214 to handle air traffic 218. Vertiport manager 206 manages allocation 220 of slots 221 to handle air traffic 218. A slot in slots 221 is a period of time. The duration of slots 221 can be heterogeneous in length. In other words, different slots in slots 221 can have different durations.

In this illustrative example, vertiport manager 206 manages allocation 220 of arrival slots 222 and departure slots 224 in slots 221 for air traffic 218 using vertiport 214 based on capacity 216 determined for vertiport 214. Additionally, vertiport manager 206 can also manage allocation 220 of service slots 226 in slots 221.

In the illustrative example, different arrival slots in arrival slots 222 can have different durations. In a similar fashion, different departure slots in departure slots 224 can have different durations, and different service slots in service slots 226 can also have different durations. In some illustrative examples, the durations can be same for the different types of slots 221.

In the illustrative example, the different slots are periods of time during which various types of operations can be performed with respect to air traffic 218 at vertiport 214. For example, arrival slots 222 are time periods during which operations with respect to the arrival of air traffic 218 can occur. Departure slots 224 are periods of time during which departure operations for air traffic 218 can occur. Service slots 226 are time periods during which operations can be worn to service aircraft. For example, a service slot can be at a gate or at a final approach and take off (FATO) area. A final approach and take off area can be used when a gate is unavailable.

In determining capacity 216 for handling air traffic 218 at vertiport 214, vertiport manager 206 can determine capacity 216 for handling air traffic 218 at vertiport 214 during time period 228 based on at least one of historical resource availability 230 at vertiport 214, historical resource usage 232 at vertiport 214, or a predicted demand 234 for vertiport resources 212 for vertiport 214.

Time period 228 can be any period of time for which capacity 216 is to be determined. For example, time period 228 can be, for example, 15 minutes, an hour, 11 hours, a day, a week, or some other period of time for which it is desirable to know capacity 216. Time period 228 can start from a current time or some future time.

Further, in determining capacity 216 for handling air traffic 218 at vertiport 214, vertiport manager 206 can take into account factors 236 for arrival slots 222, departure slots 224, and service slots 226. In this illustrative example, factors 236 can be selected from at least one of a taxiing time, a boarding time, a disembarkation time, a gate occupancy time, a battery charging time, a safety check time, a turnaround time, a number of vehicles, a type of vehicle, a number final approach and take off areas at the vertiport, a number of gates at the vertiport, a number of vehicles expected in a day, a noise regulation, or some other factor that can affect the use of the different types of slots.

As another example, in determining capacity 216 for handling air traffic 218 at vertiport 214, vertiport manager 206 can determine occupancy times 238 for a set of final approach and take off (FATO) areas 240 and a set of gates 242 at vertiport 214. As used herein, a “set of” when used with reference items means one or more items. For example, a set of final approach and take off areas 240 is one or more final approach and take off areas.

In determining capacity 216 in this example, vertiport manager 206 determines arrival slots 222, departure slots 224, and service slots 226 available for use based on occupancy times 238 determined for the set of final approach and take off areas 240 and the set of gates 242 at vertiport 214 to form capacity 216 for handling air traffic 218 at the vertiport 214. In determining arrival slots 222, departure slots 224, and service slots 226, vertiport manager 206 determines arrival slots 222, departure slots 224, and service slots 226 for use based on occupancy times 238 determined for the set of final approach and take off areas 240 and the set of gates 242 at vertiport 214.

This determination of the slots can also include vertiport manager 206 decimating portion 244 of arrival slots 222, departure slots 224, and service slots 226 available for use to form a set of decimated slots 246. The decimation of portion 244 of arrival slots 222, departure slots 224, and service slots 226 can increase flexibility to accommodate air traffic 218 when a set of unexpected events 248 occur that affect a use of capacity 216 at vertiport 214.

As a result, remaining arrival slots, remaining departure slots, and remaining service slots are arrival slots 222, departure slots 224, and service slots 226 available for use. Further, in the illustrative example, portion 244 can be any combination of arrival slots 222, departure slots 224, and service slots 226. Decimated slots 246 can be additional slots that can be used in case of undesired events and reduce issues caused by undesired events. These undesired events can be, for example, an unexpected unavailability of a final approach and take off area, whether causing rerouting of air traffic 218 to vertiport 214, and undesired power supply to a gate, or other undesired event.

In another illustrative example, the determination of the slots can include vertiport manager 206 determining arrival slots 222, departure slots 224, and service slots 226 available for use based on occupancy times 238 determined for the set of final approach and take off areas 240 and the set of gates 242 at vertiport 214. Vertiport manager 206 can add buffer 250 to at least one of arrival slots 222, departure slots 224, and service slots 226.

As a result, the addition of the buffer 250 can increase safety and reduce issues and imbalances between arriving and departing traffic. Further, the use of buffer 250 can reduce need and frequency for large-scale replanning of air traffic between vertiports. In the illustrative example, buffer 250 can be any combination of arrival slots 222, departure slots 224, and service slots 226 and are additional slots added to the slots instead of a decimation of slots.

With respect to managing the allocation slots for air traffic 218 based on capacity 216 determined from vertiport 214, vertiport manager 206 can perform reallocation 252 of at least one of arrival slot 256 in arrival slots 222, departure slot 258 in departure slots 224, or service slot 260 in service slots 226 in response to a set of unexpected events 248 that affect capacity 216 determined for vertiport 214. In this illustrative example, reallocation 252 is selected from at least one of reassigning arrival slot 256, reassigning departure slot 258, changing a duration of arrival slot 256, changing a duration of departure slot 258, changing a start time for arrival slot 256, changing the start time for the departure slot 258, assigning an unassigned departure slot, assigning an unassigned arrival slot, reassigning an assigned service slot, changing a duration of the assigned service slot, or assigning an unassigned gate.

In this illustrative example, the set of unexpected events can take a number of different forms. For example, the set of unexpected events 248 that affect capacity 216 can be selected from at least one of a flight delay of a flight using an allocated slot, a weather change, unexpected maintenance at the vertiport, an emergency request for the departure slot, the emergency request for the arrival slot, an unavailability of a flight arrival and takeoff area, an unavailability of a gate.

In managing allocation 220 of arrival slots 222, departure slots 224, and service slots 226 for air traffic 218 using vertiport 214 based on capacity 216 determined for vertiport 214, vertiport manager 206 can designate at least one of arrival slot 256, departure slot 258, or service slot 260 as reserved for use in managing allocation 220 of arrival slots 222, departure slots 224, and service slots 226 for air traffic 218 using vertiport 214 when a set of unexpected events 248 occur that affect capacity 216.

Further, in managing allocation 220 of arrival slots 222, departure slots 224, and service slots 226 for air traffic 218 using vertiport 214 based on capacity 216 determined for vertiport 214, vertiport manager 206 can receive request 262 to use vertiport 214 for a flight and identify available arrival slots 264, available departure slots 266, and available service slots 268 for meeting the request 262. In this depicted example, request 262 to use vertiport 214 can be an arrival time and duration for arrival slot 256 and departure time and duration for departure slot 258. Request 262 can also include a request for service slot 260 or vertiport manager 206 can select service slot 260 based on the request for arrival slot 256 and departure slot 258.

In another example, vertiport manager 206 can publish available arrival slots 264 to reservation system 270. Vertiport manager 206 can also publish available departure slots 266 to reservation system 270. In this example, request 262 to use vertiport 214 can be received by vertiport manager 206 from reservation system 270 and can comprise a selection of arrival slot 256 and departure slot 258 from published arrival slots and published departure slots.

Vertiport manager 206 can preallocate a set of the arrival slots 222, a set of departure slots 224, and a set of service slots 226 from the available arrival slots 264, available departure slots 266, and available service slots 268 for request 262. Vertiport manager 206 can allocate arrival slot 256, departure slot 258, and service slot 260 in response to the flight being confirmed.

In one illustrative example, one or more technical solutions are present that overcome a technical problem with balancing capacity and demand at airports. As a result, one or more technical solutions can provide a technical effect of enabling an ability to increase the amount of traffic that can be handled through the management of slots for different operations at the vertiports.

In one illustrative example, arrival slots are identified and managed in addition to departure slots at the vertiport. Further, the illustrative examples can also manage the allocation of service slots at the vertiport. By managing the allocation of arrival slots in addition to departure slots, the illustrative examples can enable balancing capacity and demand at a vertiport more efficiently as compared to techniques that only manage departure slots for departure in strategic timeframes such as mission planning.

Computer system 204 can be configured to perform at least one of the steps, operations, or actions described in the different illustrative examples using software, hardware, firmware or a combination thereof. As a result, computer system 204 operates as a special purpose computer system in which vertiport manager 206 in computer system 204 enables managing vertiport resources 212 in that it increases the ability of the vertiport to handle air traffic 218. In particular, vertiport manager 206 transforms computer system 204 into a special purpose computer system as compared to currently available general computer systems that do not have vertiport manager 206.

In the illustrative example, the use of vertiport manager 206 in computer system 204 integrates processes into a practical application for managing vertiport resources. In other words, vertiport manager 206 in computer system 204 is directed to a practical application of processes integrated into vertiport manager 206 in computer system 204 that determines a capacity for handling air traffic 218 and manages the allocation of arrival slots 222 and departure slots 224 based on capacity 216. Additionally, vertiport manager 206 can also manage the allocation of departure slots 224. As a result, managing of air traffic 218 in air vehicle management environment 200 using vertiport management system 202 can increase the amount of air traffic 218 that can be handled as compared to using current techniques.

The illustration of air vehicle management environment 200 in FIG. 2 is not meant to imply physical or architectural limitations to the manner in which an illustrative example may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative example.

For example, the management of vertiport resources 212 by vertiport manager 206 is described with respect to vertiport 214. Vertiport resources 212 can be present for additional vertiports in addition to vertiport 214. Vertiport manager 206 or other vertiport managers can manage vertiport resources 212 for those additional vertiports in addition to vertiport 214.

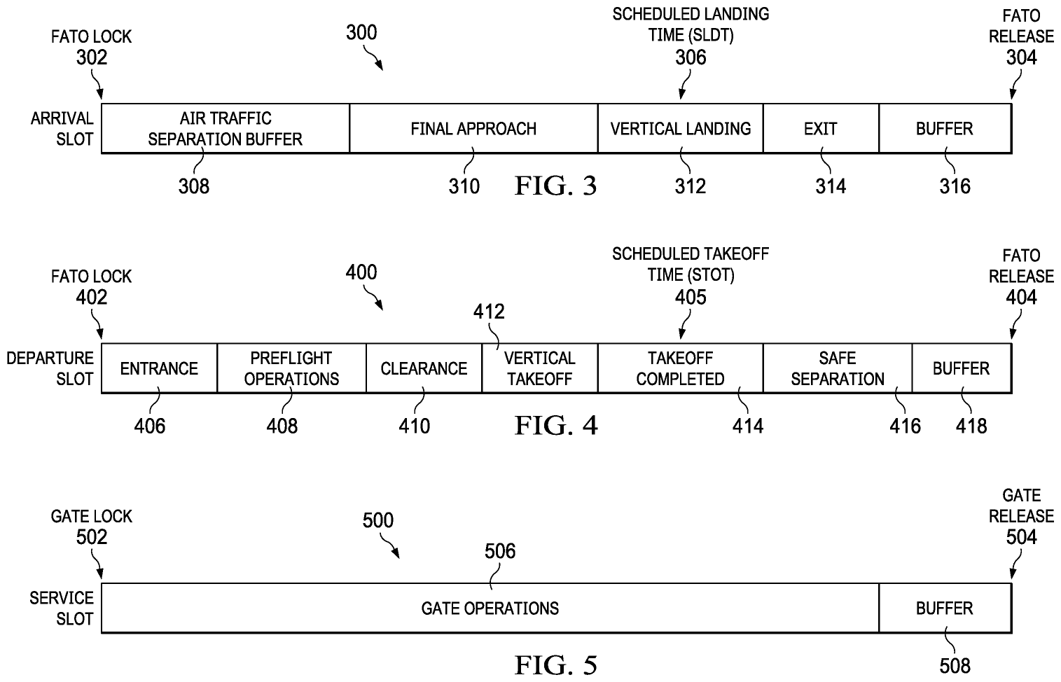

Turning next to FIG. 3, an illustration of an arrival slot is depicted in accordance with an illustrative example. Arrival slot 300 is an example of an arrival slot 256 in FIG. 2. As depicted, arrival slot 300 includes FATO lock 302, FATO release 304 and scheduled landing time (SLDT) 306. FATO lock 302 is the time at which the final approach and take off area is locked for arrival slot 300. FATO release 304 is the time at which the final approach and take off area is unlocked and available. In other words, FATO lock 302 and FATO release 304 identified the beginning and ending of arrival slot 300. Scheduled landing time (SLDT) 306 is the time at which the aircraft is scheduled to land at the final approach and take off area.

Within arrival slot 300, time periods are present for different operations that occur for arrival of an aircraft. As depicted, arrival slot 300 is divided into time periods for different operations. For example, arrival slot 300 comprises time periods for air traffic separation buffer 308, final approach 310, vertical landing 312, exit 314, and buffer 316.

Air traffic separation buffer 308 is a period of time to provide extra time in the budget allotted for absorbing time delays. These can be due to the arriving aircraft needing to maneuver to avoid other aircraft. Final approach 310 is the time in arrival slot 300 allocated for the aircraft to approach the final approach and take off area. Vertical landing 312 is the time allocated for the aircraft to land at the final approach and take off area. Exit 314 is time allocated for the aircraft to leave the final approach and take off area, which can include taxing in clearance and exiting the final approach and take off area.

Buffer 316 can be used to provide a buffer in case of uncertainty in the periods of time predicted or estimated for the different operations in arrival slot 300. In other words, buffer 316 takes into account that some operations within arrival slot 300 may take more time than anticipated. With buffer 316, reallocation of slots may be reduced or avoided when operations taking more time but do not cause the overall landing process to exceed the time allocated for arrival slot 300.

The values of these different time periods in arrival slot 300 can vary depending on a particular aircraft, final approach and take off area, weather conditions, or other factors.

With reference to FIG. 4, an illustration of a departure slot is depicted in accordance with an illustrative example. Departure slot 400 is an example of departure slot 258 in FIG. 2. As depicted, departure slot 400 includes FATO lock 402, FATO release 404 and scheduled takeoff time (STOT) 405. FATO lock 402 is the time at which the final approach and take off area is locked for departure slot 400. FATO release 404 is the time at which the final approach and take off area is unlocked and available. Scheduled takeoff time (STOT) 405 is the time at which the aircraft is scheduled to land at the final approach and take off area.

Within departure slot 400, time periods are present for different operations that occur for the departure of an aircraft. As depicted, departure slot 400 includes time periods for entrance 406, preflight operations 408, clearance 410, vertical takeoff 412, takeoff completed 414, safe separation 416, buffer 418.

In this example, entrance 406 is the time allocated for the vehicle to enter the final approach and take off area. Preflight operations 408 is the time period for various operations prior to takeoff. These operations can include, for example, vehicle towing in detachment, final preflight checks, or other operations.

Clearance 410 is the time period during which clearance for takeoff is given. Vertical takeoff 412 is time allocated for the aircraft to take off, and takeoff completed 414 is the time during which the aircraft has taken off but is still over the final approach and take off area. Safe separation 416 is the time during which the aircraft moves to a safe distance away from the final approach and take off area. Buffer 418 is additional time that can be added to take into account the different operations may take more time than anticipated.

Turning now to FIG. 5, an illustration of a service slot is depicted in accordance with an illustrative example. As depicted, service slot 500 includes gate lock 502 and gate release 504. Gate lock 502 is a time at which service slot 500 begins and the gate is locked for use by service slot 500. Gate release 504 is the time at which service slot 500 ends and the gate is released for use.

In this illustrative example, gate operations 506 occur within service slot 500. These different service operations can include, for example, refueling, inspections, maintenance, deplaning, onboarding, or other suitable operations. As depicted, service slot 500 also includes buffer 508 in addition to gate operations 506. Buffer 508 provides additional time as buffer for cases in which gate operations 506 may take more time than predicted or expected.

The illustration of the different slots in FIGS. 3-5 are provided as a depiction of some examples in which slots can be implemented. These illustrations are not meant to limit the manner in which slots can be implemented in other examples. For example, a buffer can be omitted in a slot. As another example, a service slot can be performed on a final approach and take off area instead of the gate when a gate is unavailable. As another example, vertical takeoff may also be considered to include completion of the take off while the aircraft is flying away from the final approach and take off area.

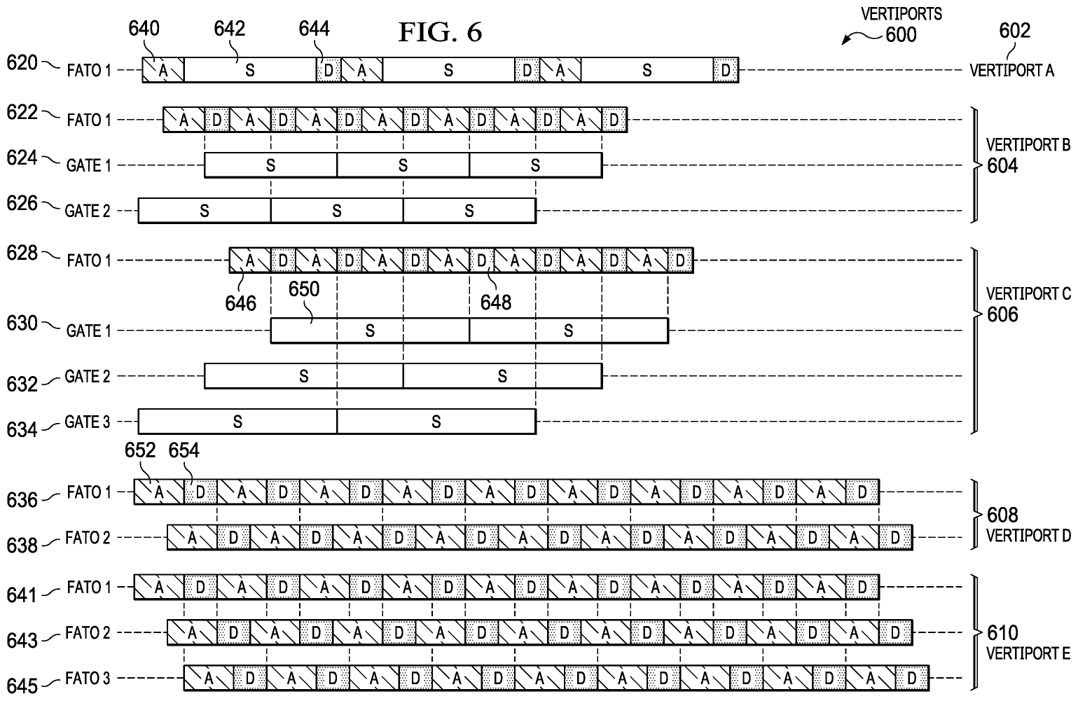

Turning now to FIG. 6, an illustration of slots allocated for vertiports is depicted in accordance with an illustrative example. As depicted, an allocation of slots is depicted for vertiports 600. Vertiports 600 comprises vertiport A 602, vertiport B 604, vertiport C 606, vertiport D 608, and vertiport E 610.

As depicted, vertiport A 602 has a single final approach and take off area, FATO 1 620 and does not have a gate. Vertiport B 604 has a single final approach and take off area, FATO 1 622, and two gates, gate 1 624 and gate 2 626. Vertiport C 606 has a single final approach and take off area, FATO 1 628, and three gates, gate 1 630, gate 2 632, and gate 3 634.

As illustrated, vertiport D 608 has two final approach and take off areas, FATO 1 636 and FATO 2 638. In this example, vertiport E 610 has three final approach and take off areas, FATO 1 641, FATO 2 643, and FATO 3 645.

In this illustrative example, the different vertiports have arrival slots and departure slots. Some vertiports also include service slots. As depicted, arrival slots are indicated by “A”, departure slots are indicated by “D”, and service slots are indicated by “S”.

As depicted in this example, without gates being present at vertiport A 602, FATO 1 620 has arrival slots, service slots, and departure slots. For example, FATO 1 620 at vertiport A 602 has slots such as arrival slot 640, service slot 642, and departure slot 644. With this example, an aircraft can land during arrival slot 640, be serviced during service slot 642, and takeoff during departure slot 644 all at FATO 1 620.

As another example, vertiport C has arrival slots, service slots, and departure slots. Arrival slots and departure slots use FATO 1 628. For example, FATO 1 628 has arrival slot 646 and departure slot 648. Gate 1 630 has service slot 650. In this example, an aircraft can land during arrival slot 646 at FATO 1 628. The aircraft can then be serviced during service slot 650 at gate 1 630 and then returned to FATO 1 628 and take off during departure slot 648.

As another example, vertiport D 608 has arrival slots and departure slots and does not include service slots. For example, FATO 1 636 at vertiport D 608 has arrival slot 652 and departure slot 654. An aircraft can land on FATO 1 636 during arrival slot 652 and takeoff during departure slot 654. Each of these slots can include time for deplaning or onboarding passengers or for unloading and loading of cargo.

The slots at vertiports 600 can be managed using a vertiport manager in a vertiport management system such as vertiport manager 206 and vertiport management system 202 in FIG. 2. The management includes the allocation of arrival slots and departure slots for at vertiport A 602, vertiport B 604, and vertiport C 606, vertiport D 608, and vertiport E 610. Additionally, when service slots are present or available, the allocation of slots can also include allocating service slots such as those at vertiport A 602, vertiport B 604, and vertiport C 606.

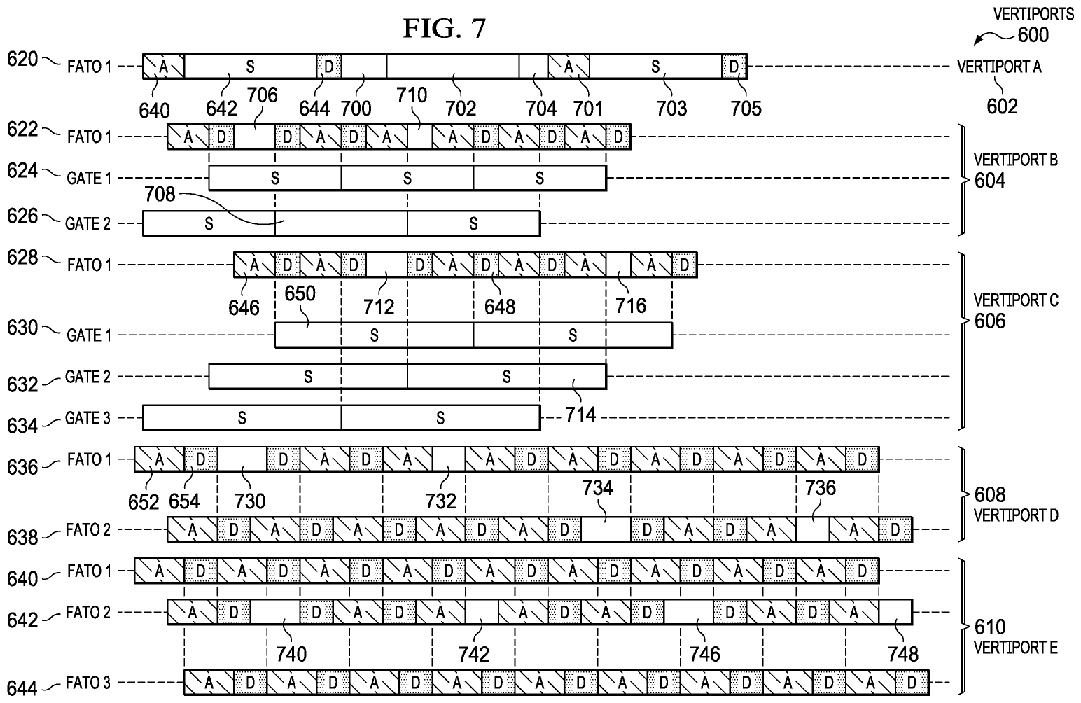

Turning to FIG. 7, an illustration of slots including decimated slots is depicted in accordance with an illustrative example. When operating a vertiport at full theoretical capacity, delays cannot be tolerated and can propagate and affect other flights in vertiports. In one illustrative example, a buffer can be added to a slot to increase flexibility in case of unexpected changes in the amount of time needed to perform the operations within the slot.

As another illustrative example, slot decimation can be performed in which slots are decimated or removed from being available for use. Slot decimation provides another level of granularity to ensure additional flexibility to accommodate unexpected events such as missed departure, or late arrival that does not fall within the allocated slots for the departure or arrival. As another example, slot decimation can provide flexibility to take into account unexpected landings or rerouting of flights due to weather.

In this illustrative example, slot decimation for vertiports 600, slot decimation provides additional flexibility in case of unexpected events. As depicted, arrival slot 700, service slot 702, and departure slot 704 for FATO 1 620 at Vertiport A 602 have been decimated.

When a slot is decimated, the slot has been removed from being allocated for use in managing air traffic on a scheduled basis. In other words, the time period for that slot can be used for other purposes such as shifting other slots if delays or other unexpected events occur.

For example, when an aircraft scheduled to take off during departure slot 644 is delayed for mechanical or maintenance reasons and does not take off during the time period for departure slot 644, the use of decimated slots can prevent or reduce the rescheduling of other flights using FATO 1 620. For example, with the decimation of arrival slot 700, service slot 702, and departure slot 704, departure slot 644 can be shifted or extended into the time for at least one of arrival slot 700, service slot 702, or departure slot 704 without affecting subsequent slots such as arrival slot 701, service slot 703, and departure slot 705 for FATO 1 620.

With vertiport B 604, arrival slot 706 for FATO 1 622 and departure slot 710 for FATO 1 610 been decimated. Service slots 708 for gate 2 626 has been decimated for vertiport B 604.

For vertiport C 606, arrival slot 712 for FATO 1 628, service slot 714 for gate 2 632, and departure slots 716 for FATO 1 628 have been decimated. As can be seen, the slots decimated in this example are selected such that the selection of an arrival slot for decimation corresponds to the service slot and departure slot that would follow from the arrival slot.

In vertiport D 608, arrival slot 730 and departure slot 732 for FATO 1 636 and been decimated, and arrival slot 734 and departure slots 736 for FATO 2 638 have been decimated. As depicted for vertiport E 610, arrival slot 740, departure slot 742, arrival slot 746, and departure slot 748 in FATO 2 643 have been decimated.

As a result, the decimation of these slots at the different vertiports can increase the tolerance that is present in the allocation of slots in response to unexpected events. For example, weather, debris on a FATO, maintenance delays, and other events can occur without having an that requires to readjustment or reallocation of slots the different vertiports.

The illustration of illustrated slots for vertiports in FIG. 6 and slot decimation in FIG. 7 are provided for purposes of demonstrating one implementation for an illustrative example. Although the different types of slots are all shown as having equal durations. Slots of a particular category can have different durations in other illustrative examples. For example, arrival slot can have different durations depending on the type of aircraft assigned to the slot. For example, a larger cargo aircraft may require a longer duration for an arrival slot as compared to a smaller two passenger aircraft.

This illustration of slots and the decimation slots is not meant to limit the manner in which other illustrative examples can be implemented. For example, slots can also be decimated for FATO 3 644 at vertiport E 610.

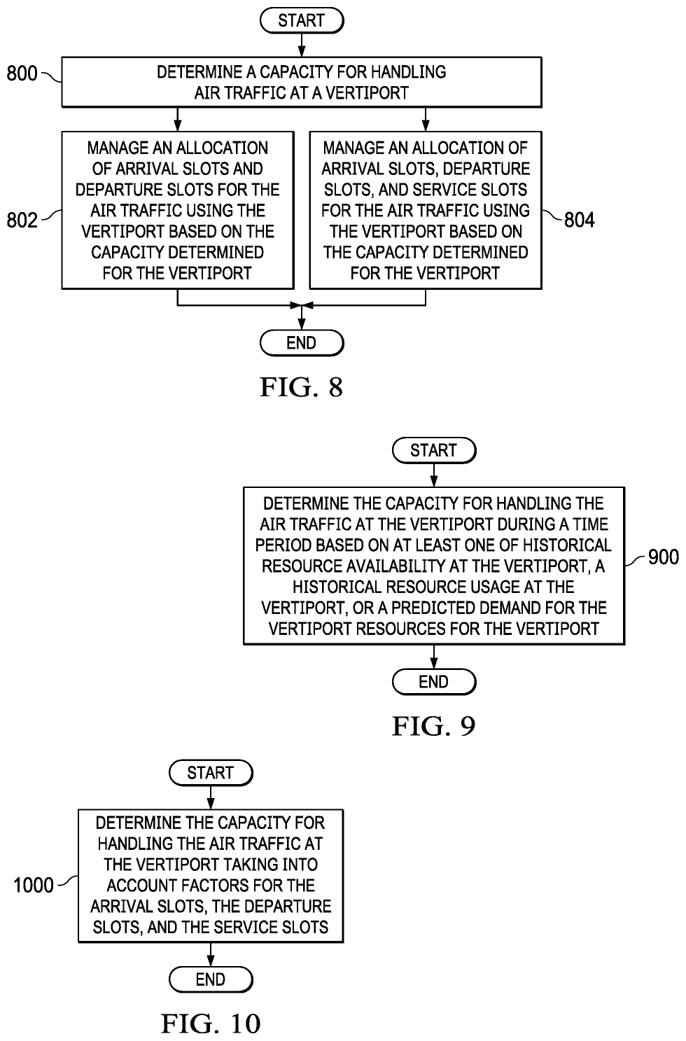

Turning next to FIG. 8, an illustration of a flowchart of a process for managing vertiport resources is depicted in accordance with an illustrative example. The process in FIG. 8 can be implemented in hardware, software, or both. When implemented in software, the process can take the form of program code that is run by one of more processor units located in one or more hardware devices in one or more computer systems. For example, the process can be implemented in vertiport manager 206 in computer system 204 in FIG. 2.

The process begins by determining a capacity for handling air traffic at a vertiport (operation 800). The process manages an allocation of arrival slots and departure slots for the air traffic using the vertiport based on the capacity determined for the vertiport (operation 802) the process terminates thereafter. In another illustrative example, the process manages an allocation of arrival slots, departure slots, and service slots for the air traffic using the vertiport based on the capacity determined for the vertiport (operation 804). This operation can be performed in place of operation 802 in some illustrative examples.

With reference to FIG. 9, an illustration of a flowchart of a process for determining capacity at a vertiport is depicted in accordance with an illustrative example. The process in FIG. 9 is an example of an implementation for operation 800 in FIG. 8.

The process determines the capacity for handling the air traffic at the vertiport during a time period based at least on one of historical resource availability at the vertiport, a historical resource usage at the vertiport, or a predicted demand for the vertiport resources for the vertiport (operation 900). The process terminates thereafter.

In FIG. 10, an illustration of a flowchart of a process for determining capacity at a vertiport is depicted in accordance with an illustrative example. The process in FIG. 10 is another example of an implementation for operation 800 in FIG. 8.

The process determines the capacity for handling the air traffic at the vertiport taking into account factors for the arrival slots, the departure slots, and the service slots (operation 1000). The process terminates thereafter. In this illustrative example, the factors comprise at least one of a taxiing time, a boarding time, a disembarkation time, a gate occupancy time, a battery charging time, a safety check time, a turnaround time, a number of vehicles, a type of vehicle, a number of final approach and take off areas at the vertiport, a number of gates at the vertiport, a number of vehicles expected in a day, a noise regulation, or some other factor that can affect the use or availability of different slots.

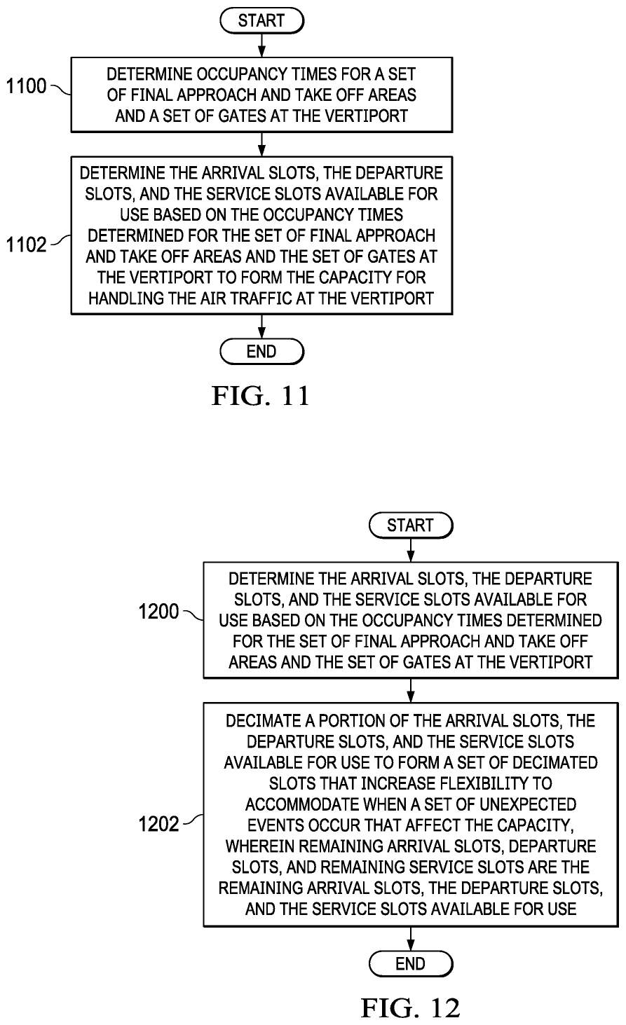

With reference next to FIG. 11, an illustration of a flowchart of a process for determining capacity at a vertiport is depicted in accordance with an illustrative example. The process in FIG. 11 is another example of an implementation for operation 800 in FIG. 8.

The process begins by determining occupancy times for a set of final approach and take off areas and a set of gates at the vertiport (operation 1100).

The process determines the arrival slots, the departure slots, and the service slots available for use based on the occupancy times determined for the set of final approach and take off areas and the set of gates at the vertiport to form the capacity for handling the air traffic at the vertiport (operation 1102). The process terminates thereafter.

Turning to FIG. 12, an illustration of a flowchart of a process for determining the arrival slots, the departure slots, and the service slots available for use is depicted in accordance with an illustrative example. The process in FIG. 12 is an example of an implementation for operation 1102 in FIG. 11.

The process determines the arrival slots, the departure slots, and the service slots available for use based on the occupancy times determined for the set of final approach and take off areas and the set of gates at the vertiport (operation 1200). The process decimates a portion of the arrival slots, the departure slots, and the service slots available for use to form a set of decimated slots that increase flexibility to accommodate when a set of unexpected events occur that affect the capacity, wherein remaining arrival slots, remaining departure slots, and remaining service slots are the arrival slots, the departure slots, and the service slots available for use (operation 1202). The process terminates thereafter.

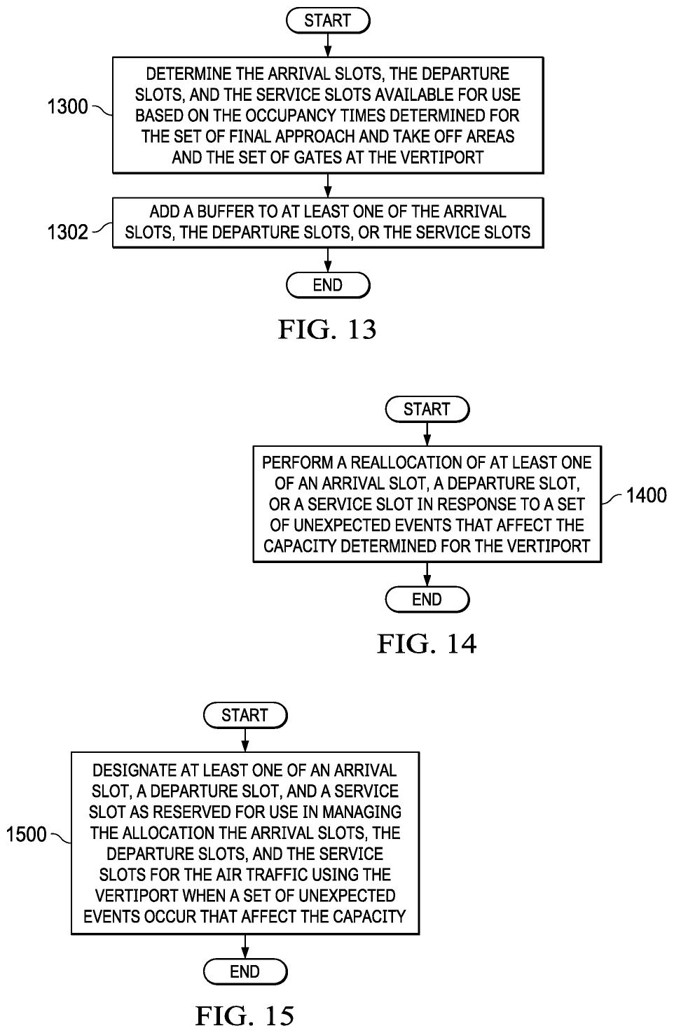

Turning now to FIG. 13, an illustration of a flowchart of a process for determining the arrival slots, the departure slots, and the service slots available for use is depicted in accordance with an illustrative example. The process in FIG. 13 is another example of an implementation for operation 1102 in FIG. 11.

The process begins by determining the arrival slots, the departure slots, and the service slots available for use based on the occupancy times determined for the set of final approach and take off areas and the set of gates at the vertiport (operation 1300). The process adds a buffer to at least one of the arrival slots, the departure slots, or the service slots (operation 1302). The process terminates thereafter.

Turning next to FIG. 14, an illustration of a flowchart of a process for managing the allocation of the arrival slots, the departure slots, and the service slots is depicted in accordance with an illustrative example. The process in FIG. 14 is an example of an implementation for operation 802 in FIG. 8.

The process performs a reallocation of at least one of an arrival slot, a departure slot, or a service slot in response to a set of unexpected events that affect the capacity determined for the vertiport (operation 1400). The process terminates thereafter.

In operation 1400, the reallocation can be performed in a number of different ways. For example, reallocation can be selected from at least one of reassigning the arrival slot, reassigning the departure slot, changing a duration of the arrival slot, changing a duration of the departure slot, changing a start time for the arrival slot, changing the start time for the departure slot, assigning an unassigned departure slot, assigning an unassigned arrival slot, reassigning an assigned service slot, changing a duration of the assigned service slot, assigning an unassigned gate, or some other type of slot reallocation.

Further, the set of unexpected events that affect the capacity can be selected from at least one of a flight delay of a flight using an allocated slot, a weather change, unexpected maintenance at the vertiport, an emergency request for the departure slot, an emergency request for the arrival slot, an unavailability of a final approach and takeoff area, an unavailability of a gate, or some other unexpected event.

With reference to FIG. 15, an illustration of a flowchart of a process for managing the allocation of the arrival slots, the departure slots, and the service slots is depicted in accordance with an illustrative example. The process in FIG. 15 is another example of an implementation for operation 802 in FIG. 8.

The process designates at least one of an arrival slot, a departure slot, and a service slot as reserved for use in managing the allocation the arrival slots, the departure slots, and the service slots for the air traffic using the vertiport when a set of unexpected events occur that affect the capacity (operation 1500). The process terminates thereafter.

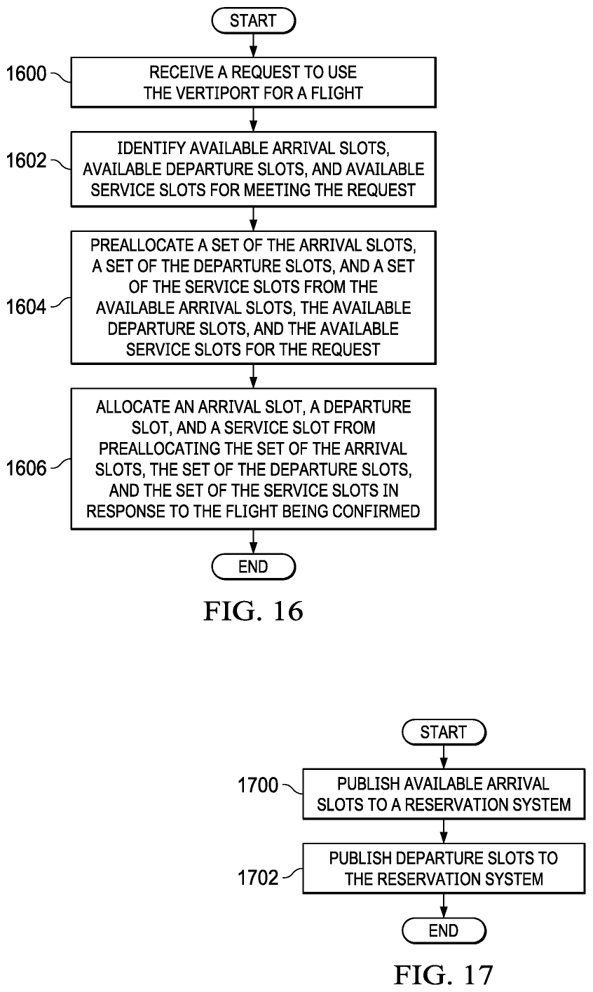

Turning now to FIG. 16, an illustration of a flowchart of a process for managing the allocation of the arrival slots, the departure slots, and the service slots is depicted in accordance with an illustrative example. The process in FIG. 16 is yet another example of an implementation for operation 802 in FIG. 8.

The process begins by receiving a request to use the vertiport for a flight (operation 1600). In operation 1600, the request to use the vertiport can comprise an arrival time and duration for an arrival slot and a departure time and duration for a departure slot. In another illustrative example, the request to use the vertiport can comprise selection of an arrival slot and a departure slot from published arrival slots and published departure slots.

The process identifies available arrival slots, available departure slots, and available service slots for meeting the request (operation 1602). The process preallocates a set of the arrival slots, a set of the departure slots, and a set of the service slots from the available arrival slots, the available departure slots, and the available service slots for the request (operation 1604).

The process allocates an arrival slot, a departure slot, and a service slot preallocating the set of the arrival slots, a set of the departure slots, and a set of the service slots in response to the flight being confirmed (operation 1606). The process terminates thereafter.

With reference to FIG. 17, an illustration of a flowchart of a process for managing the allocation of the arrival slots, the departure slots, and the service slots is depicted in accordance with an illustrative example. The process in FIG. 17 is an example of additional operations that can be performed with the operations in FIG. 8.

The process publishes available arrival slots to a reservation system (operation 1700). The process publishes departure slots to the reservation system (operation 1702). The process terminates thereafter.

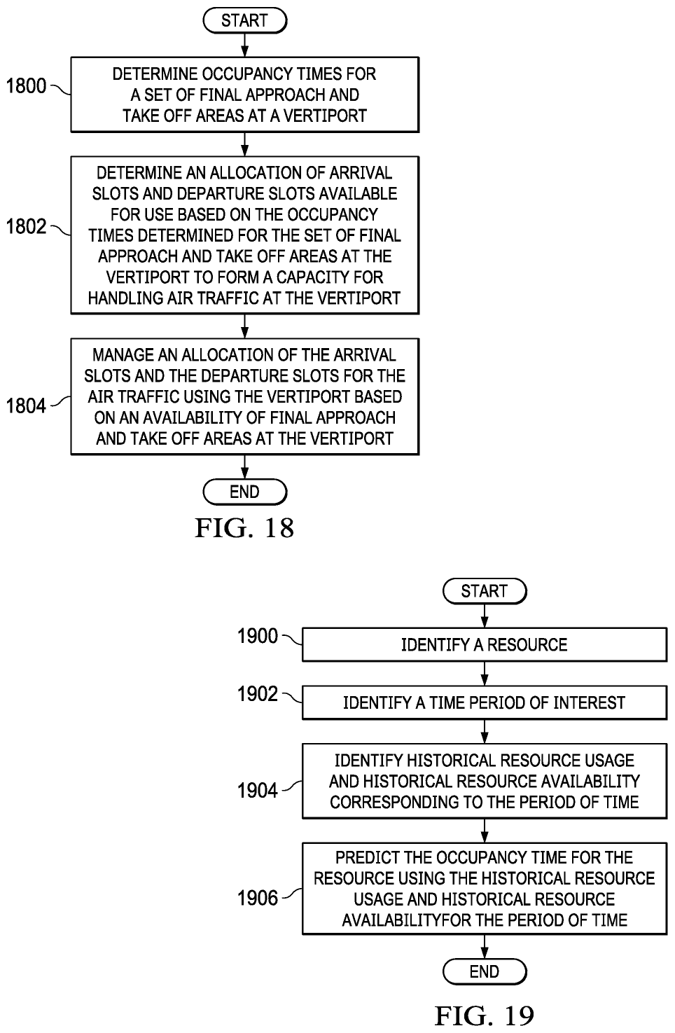

Turning next to FIG. 18, an illustration of a flowchart of a process for managing vertiport resources is depicted in accordance with an illustrative example. The process in FIG. 18 can be implemented in hardware, software, or both. When implemented in software, the process can take the form of program code that is run by one of more processor units located in one or more hardware devices in one or more computer systems. For example, the process can be implemented in vertiport manager 206 in computer system 204 in FIG. 2.

The process begins by determining occupancy times for a set of final approach and take off areas at a vertiport (operation 1800). In operation 1800, the process can also take into account the presence of gates and determines occupancy times for a set of final approach and take off areas and a set of gates at a vertiport.

The process determines an allocation of arrival slots and departure slots available for use based on the occupancy times determined for the set of final approach and take off areas at the vertiport to form a capacity for handling air traffic at the vertiport (operation 1802). In operation 1802, the process can also take into account the presence of gates and determines an allocation of arrival slots, departure slots, and service slots available for use based on the occupancy times determined for the set of final approach and take off areas and the set of gates at the vertiport to form a capacity for handling air traffic at the vertiport.

The process manages an allocation of the arrival slots and the departure slots for the air traffic using the vertiport based on an availability of final approach and take off areas at the vertiport (operation 1804). The process terminates thereafter. In operation 1804 when service slots and gates are present, the process can manage an allocation of the arrival slots, the departure slots, and service slots for the air traffic using the vertiport based on an availability of final approach and take off areas and the set of gates at the vertiport.

In some illustrative examples, the process can manage the allocation of arrival slots and departure slots and can also include managing the allocation of service slots. In this example, service slots may not be a limiting factor in assigning arrival slots and departures slots.

Turning next to FIG. 19, an illustration of a flowchart of process for determining occupancy time is depicted in accordance with an illustrative example. This process is an example of an implementation for operation 1100 in FIG. 11 and operation 1800 in FIG. 18.

The process begins by identifying a resource (operation 1900). In operation 1900, the resource can be a final approach and take off area, a gate, or other resource which an aircraft can occupy.

The process identifies a time period of interest (operation 1902). In this illustrative example, the time period of interest is a future period of time and can be, for example, an hour, 12 hours, a day, a week, or some other period of time.

The process identifies historical resource usage and historical resource availability corresponding to the period of time (operation 1904). For example, if the time period is for a day of the week, such as Tuesday, historical resource usage and historical resource availability can be identified for Tuesdays. As another example, the historical resource usage and historical resource availability can be determined for the period of time from 6:00 am to 12:00 pm on a daily basis. In yet another illustrative example, the historical resource usage and historical resource availability can be evaluated for Tuesdays in June.

The process predicts the occupancy time for the resource using the historical resource usage and historical resource availability for the period of time (operation 1906). The process terminates thereafter.

This prediction can be made in a number of different ways. For example, an artificial intelligence system can be used to predict occupancy times. For example, a machine learning model can be used to predict occupancy times during the selected period of time.

An artificial intelligence system is a system that has intelligent behavior and can be based on the function of a human brain. An artificial intelligence system comprises at least one of an artificial neural network, a cognitive system, a Bayesian network, a fuzzy logic, an expert system, a natural language system, or some other suitable system. Machine learning can be used to train the artificial intelligence system. Machine learning involves inputting data to the process and allowing the process to adjust and improve the function of the artificial intelligence system.

A machine learning model is a type of artificial intelligence model that can learn without being explicitly programmed. A machine learning model can learn based on training data input into the machine learning model. The machine learning model can learn using various types of machine learning algorithms. The machine learning algorithms include at least one of a supervised learning, an unsupervised learning, a feature learning, a sparse dictionary learning, an anomaly detection, association rules, or other types of learning algorithms. Examples of machine learning models include an artificial neural network, a decision tree, a support vector machine, a Bayesian network, a genetic algorithm, and other types of models. These machine learning models can be trained using data and process additional data to provide a desired output.

This process can be repeated to identify occupancy time for final approach and take off areas, gates, or other areas. This information can then be used to manage the allocation of slots at the vertiport.

The flowcharts and block diagrams in the different depicted embodiments illustrate the architecture, functionality, and operation of some possible implementations of apparatuses and methods in an illustrative example. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware can, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams can be implemented using special purpose hardware systems that perform the different operations or combinations of special purpose hardware and program code run by the special purpose hardware.

In some alternative implementations of an illustrative example, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

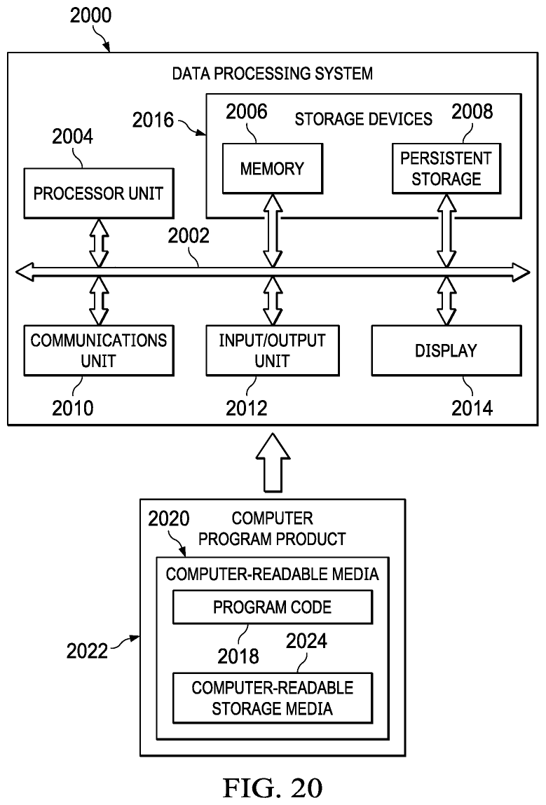

Turning now to FIG. 20, an illustration of a block diagram of a data processing system is depicted in accordance with an illustrative example. Data processing system 2000 can be used to implement computer system 204 in FIG. 2. In this illustrative example, data processing system 2000 includes communications framework 2002, which provides communications between processor unit 2004, memory 2006, persistent storage 2008, communications unit 2010, input/output (I/O) unit 2012, and display 2014. In this example, communications framework 2002 takes the form of a bus system.

Processor unit 2004 serves to execute instructions for software that can be loaded into memory 2006. Processor unit 2004 includes one or more processors. For example, processor unit 2004 can be selected from at least one of a multicore processor, a central processing unit (CPU), a graphics processing unit (GPU), a physics processing unit (PPU), a digital signal processor (DSP), a network processor, or some other suitable type of processor. Further, processor unit 2004 can may be implemented using one or more heterogeneous processor systems in which a main processor is present with secondary processors on a single chip. As another illustrative example, processor unit 2004 can be a symmetric multi-processor system containing multiple processors of the same type on a single chip.

Memory 2006 and persistent storage 2008 are examples of storage devices 2016. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 2016 may also be referred to as computer-readable storage devices in these illustrative examples. Memory 2006, in these examples, can be, for example, a random-access memory or any other suitable volatile or non-volatile storage device. Persistent storage 2008 can take various forms, depending on the particular implementation.

For example, persistent storage 2008 may contain one or more components or devices. For example, persistent storage 2008 can be a hard drive, a solid-state drive (SSD), a flash memory, a rewritable optical disk, a rewritable magnetic tape, or some combination of the above. The media used by persistent storage 2008 also can be removable. For example, a removable hard drive can be used for persistent storage 2008.

Communications unit 2010, in these illustrative examples, provides for communications with other data processing systems or devices. In these illustrative examples, communications unit 2010 is a network interface card.

Input/output unit 2012 allows for input and output of data with other devices that can be connected to data processing system 2000. For example, input/output unit 2012 can provide a connection for user input through at least one of a keyboard, a mouse, or some other suitable input device. Further, input/output unit 2012 can send output to a printer. Display 2014 provides a mechanism to display information to a user.

Instructions for at least one of the operating system, applications, or programs can be located in storage devices 2016, which are in communication with processor unit 2004 through communications framework 2002. The processes of the different embodiments can be performed by processor unit 2004 using computer-implemented instructions, which can be located in a memory, such as memory 2006.

These instructions are program instructions and are also referred to as program code, computer usable program code, or computer-readable program code that can be read and executed by a processor in processor unit 2004. The program code in the different embodiments can be embodied on different physical or computer-readable storage media, such as memory 2006 or persistent storage 2008.

Program code 2018 is located in a functional form on computer-readable media 2020 that is selectively removable and can be loaded onto or transferred to data processing system 2000 for execution by processor unit 2004. Program code 2018 and computer-readable media 2020 form computer program product 2022 in these illustrative examples. In the illustrative example, computer-readable media 2020 is computer-readable storage media 2024.

Computer-readable storage media 2024 is a physical or tangible storage device used to store program code 2018 rather than a media that propagates or transmits program code 2018. Computer-readable storage media 2020, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 2018 can be transferred to data processing system 2000 using a computer-readable signal media. The computer-readable signal media are signals and can be, for example, a propagated data signal containing program code 2018. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 2020” can be singular or plural. For example, program code 2018 can be located in computer-readable media 2020 in the form of a single storage device or system. In another example, program code 2018 can be located in computer-readable media 2020 that is distributed in multiple data processing systems. In other words, some instructions in program code 2018 can be located in one data processing system while other instructions in program code 2018 can be located in another data processing system. For example, a portion of program code 2018 can be located in computer-readable media 2020 in a server computer while another portion of program code 2018 can be located in computer-readable media 2020 located in a set of client computers.

The different components illustrated for data processing system 2000 are not meant to provide architectural limitations to the manner in which different embodiments can be implemented. In some illustrative examples, one or more of the components may be incorporated in or otherwise form a portion of, another component. For example, memory 2006, or portions thereof, can be incorporated in processor unit 2004 in some illustrative examples. The different illustrative examples can be implemented in a data processing system including components in addition to or in place of those illustrated for data processing system 2000. Other components shown in FIG. 20 can be varied from the illustrative examples shown. The different embodiments can be implemented using any hardware device or system capable of running program code 2018.

Some features of the illustrative examples are described in the following clauses. These clauses are examples of features not intended to limit other illustrative examples.

Clause 1

A method for managing vertiport resources, the method comprising:
determining, by a computer system, a capacity for handling air traffic at a vertiport; and
managing, by the computer system, an allocation of arrival slots, departure slots, and service slots for the air traffic using the vertiport based on the capacity determined for the vertiport.

Clause 2

The method according to clause 1, wherein determining, by the computer system, the capacity for handling the air traffic at the vertiport comprises:
determining, by the computer system, the capacity for handling the air traffic at the vertiport during a time period based on at least one of historical resource availability at the vertiport, a historical resource usage at the vertiport, or a predicted demand for the vertiport resources for the vertiport.

Clause 3

The method according to one of clauses 1 or 2, wherein determining, by the computer system, the capacity at the vertiport comprises:
determining, by the computer system, the capacity for handling the air traffic at the vertiport taking into account factors for the arrival slots, the departure slots, and the service slots.

Clause 4

The method according to 3, wherein the factors comprise at least one of a taxiing time, a boarding time, a disembarkation time, a gate occupancy time, a battery charging time, a safety check time, a turnaround time, a number of vehicles, a type of vehicle, a number of final approach and take off areas at the vertiport, a number of gates at the vertiport, a number of vehicles expected in a day, or a noise regulation.

Clause 5

The method according to one of clauses 1, 2, 3, or 4, wherein determining, by the computer system, the capacity for handling the air traffic at the vertiport comprises:
determining, by the computer system, occupancy times for a set of final approach and take off areas and a set of gates at the vertiport; and
determining, by the computer system, the arrival slots, the departure slots, and the service slots available for use based on the occupancy times determined for the set of final approach and take off areas and the set of gates at the vertiport to form the capacity for handling the air traffic at the vertiport.

Clause 6

The method according to clause 5, wherein determining, by the computer system, the arrival slots, the departure slots, and the service slots available for use based on the occupancy times determined for the set of final approach and take off areas and the set of gates at the vertiport to form the capacity for handling the air traffic at the vertiport comprises:
determining, by the computer system, the arrival slots, the departure slots, and the service slots available for use based on the occupancy times determined for the set of final approach and take off areas and the set of gates at the vertiport; and
decimating, by the computer system, a portion of the arrival slots, the departure slots, and the service slots available for use to form a set of decimated slots that increase flexibility to accommodate when a set of unexpected events occur that affect the capacity, wherein remaining arrival slots, remaining departure slots, and remaining service slots are the arrival slots, the departure slots, and the service slots available for use.

Clause 7

The method according to one of clauses 5 or 6, wherein determining, by the computer system, the arrival slots, the departure slots, and the service slots available for use based on the occupancy times determined for the set of final approach and take off areas and the set of gates at the vertiport to form the capacity for handling the air traffic at the vertiport comprises:
determining, by the computer system, the arrival slots, the departure slots, and the service slots available for use based on the occupancy times determined for the set of final approach and take off areas and the set of gates at the vertiport; and
adding, by the computer system, a buffer to at least one of the arrival slots, the departure slots, or the service slots.

Clause 8

The method according to one of clauses 1, 2, 3, 4, 5, 6, or 7, wherein managing, by the computer system, the allocation of the arrival slots, the departure slots, and the service slots for the air traffic using the vertiport based on the capacity determined for the vertiport comprises:
performing, by the computer system, a reallocation of at least one of an arrival slot, a departure slot, or a service slot in response to a set of unexpected events that affect the capacity determined for the vertiport.

Clause 9

The method according to clause 8, wherein the reallocation is selected from at least one of reassigning the arrival slot; reassigning the departure slot, changing a duration of the arrival slot; changing a duration of the departure slot, changing a start time for the arrival slot; changing the start time for the departure slot, assigning an unassigned departure slot; assigning an unassigned arrival slot; reassigning an assigned service slot; changing a duration of the assigned service slot; or assigning an unassigned gate

Clause 10

The method according to one of clauses 8 or 9, wherein the set of unexpected events that affect the capacity is selected from at least one of a flight delay of a flight using an allocated slot, a weather change, unexpected maintenance at the vertiport, an emergency request for the departure slot, the emergency request for the arrival slot, an unavailability of a final approach and takeoff area, or an unavailability of a gate.

Clause 11

The method according to one of clauses 1, 2, 3, 4, 5, 6, 7, 8, 9, or 10, wherein managing, by the computer system, the allocation of the arrival slots, the departure slots, and the service slots for the air traffic using the vertiport based on the capacity determined for the vertiport comprises:
designating, by the computer system, at least one of an arrival slot, a departure slot, and a service slot as reserved for use in managing the allocation the arrival slots, the departure slots, and the service slots for the air traffic using the vertiport when a set of unexpected events occur that affect the capacity.

Clause 12

The method according to one of clauses 1, 2, 3, 4, 5, 6, 7, 8, 9, 10, or 11, wherein managing, by the computer system, the allocation of the arrival slots, the departure slots, and the service slots for the air traffic using the vertiport comprises:
receiving, by the computer system, a request to use the vertiport for a flight;
identifying, by the computer system, available arrival slots, available departure slots, and available service slots for meeting the request;
preallocating, by the computer system, a set of the arrival slots, a set of the departure slots, and a set of the service slots from the available arrival slots, the available departure slots, and the available service slots for the request; and
allocating, by the computer system, an arrival slot, a departure slot, and a service slot from preallocating the set of the arrival slots, the set of the departure slots, and the set of the service slots in response to the flight being confirmed.

Clause 13

The method according to clause 12, wherein the request to use the vertiport comprises an arrival time and duration for an arrival slot and a departure time and duration for a departure slot.

Clause 14

The method according to one of clause 12 or 13, wherein the request to use the vertiport comprises selection of an arrival slot and a departure slot from published arrival slots and published departure slots.

Clause 15

The method according to one of clauses 1, 2, 3, 4, 5, 6, 7, 8, 9, 10, 11, 12, 13, or 14 further comprising:
publishing, by the computer system, available arrival slots to a reservation system.

Clause 16

The method according to clause 15 further comprising:
publishing, by the computer system, available departure slots to the reservation system.

Clause 17.

A method for managing vertiport resources, the method comprising:
determining, by a computer system, occupancy times for a set of final approach and take off areas and a set of gates at a vertiport;
determining, by the computer system, an allocation of arrival slots and departure slots available for use based on the occupancy times determined for the set of final approach and take off areas and the set of gates at the vertiport to form a capacity for handling air traffic at the vertiport; and
managing, by the computer system, an allocation of the arrival slots and the departure slots for the air traffic using the vertiport based on an availability of the final approach and take off areas and the gates at the vertiport.

Clause 18

The method according to clause 17, wherein managing, by the computer system, the allocation of the arrival slots and the departure slots for the air traffic using the vertiport based on the availability of the final approach and take off areas and the gates at the vertiport comprises:
performing, by the computer system, a reallocation of at least one of an arrival slot or a departure slot in response to a set of unexpected events that affect the capacity occurring during operation of the vertiport.

Clause 19

The method according to clause 18, wherein the reallocation is selected from at least one of reassigning the arrival slot; reassigning the departure slot; changing a duration of the arrival slot; changing a duration of the departure slot, changing a start time for the arrival slot; changing the start time for the departure slot; assigning an unassigned departure slot; or assigning an unassigned arrival slot.

Clause 20

The method according to one of clause 18 or 19, wherein the set of unexpected events that affect the capacity is selected from at least one of a flight delay of a flight using an allocated slot, a weather change, unexpected maintenance at the vertiport, an emergency request for the departure slot, the emergency request for the arrival slot, an unavailability of a final approach and take off area, or an unavailability of a gate.

Clause 21

A vertiport management system comprising:
a computer system; and
a vertiport manager in the computer system, wherein the vertiport manager operates to:
determine a capacity for handling air traffic at a vertiport; and
manage an allocation of arrival slots, departure slots, and service slots for the air traffic using the vertiport based on the capacity determined for the vertiport.

Clause 22

The vertiport management system according to clause 21, wherein in determining the capacity for handling the air traffic at the vertiport, the vertiport manager operates to:
determine the capacity for handling the air traffic at the vertiport during a time period based on at least one of a historical resource availability at the vertiport, a historical resource usage at the vertiport, or a predicted demand for vertiport resources for the vertiport,

Clause 23

The vertiport management system according to one of clause 21 or 22, wherein in determining a capacity at the vertiport, the vertiport manager operates to:
determine the capacity for handling the air traffic at the vertiport taking into account factors for the arrival slots, the departure slots, and the service slots.

Clause 24

The vertiport management system according to clause 23, wherein the factors comprise at least one of a taxiing time, a boarding time, a disembarkation time, a gate occupancy time, a battery charging time, a safety check time, a turnaround time, a number of vehicles, a type of vehicle, a number of final approach and take off areas at the vertiport, a number of gates at the vertiport, a number of vehicles expected in a day, or a noise regulation.

Clause 25

The vertiport management system according to clause 21, 22, 23, or 24, wherein in determining the capacity for handling the air traffic at the vertiport, the vertiport manager operates to:
determine occupancy times for a set of final approach and take off areas and a set of gates at the vertiport; and
determine the arrival slots, the departure slots, and the service slots available for use based on the occupancy times determined for the set of final approach and take off areas and the set of gates at the vertiport to form the capacity for handling the air traffic at the vertiport.

Clause 26

The vertiport management system according to clause 25, wherein in determining the arrival slots, the departure slots, and the service slots available for use based on the occupancy times determined for the set of final approach and take off areas and the set of gates at the vertiport to form the capacity for handling the air traffic at the vertiport, the vertiport manager operates to:
determine the arrival slots, the departure slots, and the service slots available for use based on the occupancy times determined for the set of final approach and take off areas and the set of gates at the vertiport; and
decimate a portion of the arrival slots, the departure slots, and the service slots available for use to form a set of decimated slots that increase flexibility to accommodate when a set of unexpected events occur, wherein remaining arrival slots, remaining departure slots, and remaining service slots are the arrival slots, the departure slots, and the service slots available for use.

Clause 27

The vertiport management system according to clause 25 or 26, wherein in determining the arrival slots, the departure slots, and the service slots available for use based on the occupancy times determined for the set of final approach and take off areas and the set of gates at the vertiport to form the capacity for handling the air traffic at the vertiport, the vertiport manager operates to:
determine the arrival slots, the departure slots, and the service slots available for use based on the occupancy times determined for the set of final approach and take off areas and the set of gates at the vertiport; and
add a buffer to at least one of the arrival slots, the departure slots, or the service slots.

Clause 28

The vertiport management system according to clause 21, 22, 23, 24, 25, 26, or 27, wherein in managing the allocation of the arrival slots, the departure slots, and the service slots for the air traffic using the vertiport based on the capacity determined for the vertiport, the vertiport manager operates to:
perform a reallocation of at least one of an arrival slot, a departure slot, or a service slot in response to a set of unexpected events that affect the capacity determined for the vertiport.

Clause 29

The vertiport management system according to clause 28, wherein the reallocation is selected from at least one of reassigning the arrival slot; reassigning the departure slot; changing a duration of the arrival slot; changing a duration of the departure slot; changing a start time for an arrival slot; changing the start time for the departure slot; assigning an unassigned departure slot, assigning an unassigned arrival slot; reassigning an assigned service slot; changing a duration of the assigned service slot, or assigning an unassigned gate.

Clause 30

The vertiport management system according to clause 28 or 29, wherein the set of unexpected events that affect the capacity is selected from at least one of a flight delay of a flight using an allocated slot, a weather change, unexpected maintenance at the vertiport, an emergency request for the departure slot, the emergency request for the arrival slot; an unavailability of a final approach and take off area, or an unavailability of a gate.

Clause 31

The vertiport management system according to clause 21, 22, 23, 24, 25, 26, 28, 29, or 30, wherein in managing the allocation of the arrival slots, the departure slots, and the service slots for the air traffic using the vertiport based on the capacity determined for the vertiport, the vertiport manager operates to:
designate at least one of an arrival slot, a departure slot, and a service slot as reserved for use in managing the allocation of the arrival slots, the departure slots, or the service slots for the air traffic using the vertiport when a set of unexpected events occurs.

Clause 32

The vertiport management system according to clause 21, 22, 23, 24, 25, 26, 28, 29, 30, or 31, wherein in managing the allocation of the arrival slots, the departure slots, and the service slots for the air traffic using the vertiport, the vertiport manager operates to:
receive a request to use the vertiport for a flight;
identify available arrival slots, available departure slots, and available service slots for meeting the request;
preallocate a set of the arrival slots, a set of the departure slots, and a set of the service slots from the available arrival slots, the available departure slots, and the available service slots for the request; and
allocate an arrival slot, a departure slot, and a service slot from preallocating the set of the arrival slots, a set of the departure slots, and a set of the service slots in response to the flight being confirmed.

Clause 33

The vertiport management system according to clause 32, wherein the request to use the vertiport comprises an arrival time and duration for an arrival slot and a departure time and duration for a departure slot.

34. The vertiport management system of according to clause 32 or 33, wherein the request to use the vertiport comprises selection of an arrival slot and a departure slot from published arrival slots and published departure slots.

Clause 35

A vertiport management system comprising:
a computer system; and
a vertiport manager in the computer system, wherein the vertiport manager operates to:
determine occupancy times for a set of final approach and take off areas at a vertiport;
determine an allocation of arrival slots and departure slots available for use based on the occupancy times determined for the set of final approach and take off areas at the vertiport to form a capacity for handling air traffic at the vertiport; and
manage an allocation of the arrival slots, the departure slots, and service slots for the air traffic using the vertiport based on an availability of final approach and take off areas at the vertiport.

Clause 36

The vertiport management system according to clause 35, wherein in managing the allocation of the arrival slots and the departure slots, for the air traffic using the vertiport based on the availability of final approach and take off areas at the vertiport, the vertiport manager operates to:
perform a reallocation of at least one of an arrival slot, a departure slot, or a service slot in response to a set of unexpected events that affect the capacity occurring during operation of the vertiport.

Clause 37

The vertiport management system according to clause 36, wherein the reallocation is selected from at least one of reassigning the arrival slot; reassigning the departure slot, changing a duration of the arrival slot; changing a duration of the departure slot; changing a start time for the arrival slot; changing the start time for the departure slot; assigning an unassigned departure slot; or assigning an unassigned arrival slot.

Clause 38
The vertiport management system according clause 36 or 37, wherein the set of unexpected events that affect the capacity is selected from at least one of a flight delay of a flight using an allocated slot, a weather change, unexpected maintenance at the vertiport, an emergency request for the departure slot, the emergency request for the arrival slot, an unavailability of a final approach and take off area, or an unavailability of a gate.

Thus, the illustrative of examples provided method, apparatus, system, and computer program product for managing vertiport resources. In an illustrative example, a vertiport management system can manage vertiport resources can operate to determine a capacity for handling air traffic at a vertiport. The allocation of slots such as arrival slots and departure slots can be managed for the air traffic using the vertiport based on capacity determined for the vertiport. Additionally, the process can also manage the allocation of service slots for air traffic using the vertiport.

In one or more illustrative examples of a vertiport to handle air traffic can be increased through managing arrival slots in addition to departure slots at the vertiport. This management of air traffic can also include managing service slots at the vertiport. As a result, the use of vertiport resources such as final approach and take off areas can be used to increased capacity with the desired level of safety.

The description of the different illustrative examples has been presented for purposes of illustration and description and is not intended to be exhaustive or limited to the embodiments in the form disclosed. The different illustrative examples describe components that perform actions or operations. In an illustrative example, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative examples may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A method for managing vertiport resources, the method comprising:
determining, by a computer system, a capacity for handling air traffic at a vertiport; and
managing, by the computer system, an allocation of arrival slots, departure slots, and service slots for the air traffic using the vertiport based on the capacity determined for the vertiport.

2. The method of claim 1, wherein determining, by the computer system, the capacity for handling the air traffic at the vertiport comprises:
determining, by the computer system, the capacity for handling the air traffic at the vertiport during a time period based on at least one of historical resource availability at the vertiport, a historical resource usage at the vertiport, or a predicted demand for the vertiport resources for the vertiport.

3. The method of claim 1, wherein determining, by the computer system, the capacity at the vertiport comprises:
determining, by the computer system, the capacity for handling the air traffic at the vertiport taking into account factors for the arrival slots, the departure slots, and the service slots.

4. The method of claim 3, wherein the factors comprise at least one of a taxiing time, a boarding time, a disembarkation time, a gate occupancy time, a battery charging time, a safety check time, a turnaround time, a number of vehicles, a type of vehicle, a number of final approach and take off areas at the vertiport, a number of gates at the vertiport, a number of vehicles expected in a day, or a noise regulation.

5. The method of claim 1, wherein determining, by the computer system, the capacity for handling the air traffic at the vertiport comprises:
determining, by the computer system, occupancy times for a set of final approach and take off areas and a set of gates at the vertiport; and
determining, by the computer system, the arrival slots, the departure slots, and the service slots available for use based on the occupancy times determined for the set of final approach and take off areas and the set of gates at the vertiport to form the capacity for handling the air traffic at the vertiport.

6. The method of claim 5, wherein determining, by the computer system, the arrival slots, the departure slots, and the service slots available for use based on the occupancy times determined for the set of final approach and take off areas and the set of gates at the vertiport to form the capacity for handling the air traffic at the vertiport comprises:
determining, by the computer system, the arrival slots, the departure slots, and the service slots available for use based on the occupancy times determined for the set of final approach and take off areas and the set of gates at the vertiport; and
decimating, by the computer system, a portion of the arrival slots, the departure slots, and the service slots available for use to form a set of decimated slots that increase flexibility to accommodate when a set of unexpected events occur that affect the capacity, wherein remaining arrival slots, remaining departure slots, and remaining service slots are the arrival slots, the departure slots, and the service slots available for use.

7. The method of claim 5, wherein determining, by the computer system, the arrival slots, the departure slots, and the service slots available for use based on the occupancy times determined for the set of final approach and take off areas and the set of gates at the vertiport to form the capacity for handling the air traffic at the vertiport comprises:
determining, by the computer system, the arrival slots, the departure slots, and the service slots available for use based on the occupancy times determined for the set of final approach and take off areas and the set of gates at the vertiport; and
adding, by the computer system, a buffer to at least one of the arrival slots, the departure slots, or the service slots.

8. The method of claim 1, wherein managing, by the computer system, the allocation of the arrival slots, the departure slots, and the service slots for the air traffic using the vertiport based on the capacity determined for the vertiport comprises:
performing, by the computer system, a reallocation of at least one of an arrival slot, a departure slot, or a service slot in response to a set of unexpected events that affect the capacity determined for the vertiport.

9. The method of claim 8, wherein the reallocation is selected from at least one of reassigning the arrival slot; reassigning the departure slot, changing a duration of the arrival slot; changing a duration of the departure slot, changing a start time for the arrival slot; changing the start time for the departure slot, assigning an unassigned departure slot; assigning an unassigned arrival slot; reassigning an assigned service slot; changing a duration of the assigned service slot; or assigning an unassigned gate.

10. The method of claim 8, wherein the set of unexpected events that affect the capacity is selected from at least one of a flight delay of a flight using an allocated slot, a weather change, unexpected maintenance at the vertiport, an emergency request for the departure slot, the emergency request for the arrival slot, an unavailability of a final approach and takeoff area, or an unavailability of a gate.

11. The method of claim 1, wherein managing, by the computer system, the allocation of the arrival slots, the departure slots, and the service slots for the air traffic using the vertiport based on the capacity determined for the vertiport comprises:
designating, by the computer system, at least one of an arrival slot, a departure slot, and a service slot as reserved for use in managing the allocation the arrival slots, the departure slots, and the service slots for the air traffic using the vertiport when a set of unexpected events occur that affect the capacity.

12. The method of claim 1, wherein managing, by the computer system, the allocation of the arrival slots, the departure slots, and the service slots for the air traffic using the vertiport comprises:
receiving, by the computer system, a request to use the vertiport for a flight;
identifying, by the computer system, available arrival slots, available departure slots, and available service slots for meeting the request;
preallocating, by the computer system, a set of the arrival slots, a set of the departure slots, and a set of the service slots from the available arrival slots, the available departure slots, and the available service slots for the request; and
allocating, by the computer system, an arrival slot, a departure slot, and a service slot from preallocating the set of the arrival slots, the set of the departure slots, and the set of the service slots in response to the flight being confirmed.

13. The method of claim 12, wherein the request to use the vertiport comprises an arrival time and duration for an arrival slot and a departure time and duration for a departure slot.

14. The method of claim 12, wherein the request to use the vertiport comprises selection of an arrival slot and a departure slot from published arrival slots and published departure slots.

15. The method of claim 1 further comprising:
publishing, by the computer system, available arrival slots to a reservation system.

16. The method of claim 15 further comprising:
publishing, by the computer system, available departure slots to the reservation system.

17.-20. (canceled)

21. A vertiport management system comprising:
a computer system; and
a vertiport manager in the computer system, wherein the vertiport manager operates to:
determine a capacity for handling air traffic at a vertiport; and
manage an allocation of arrival slots, departure slots, and service slots for the air traffic using the vertiport based on the capacity determined for the vertiport.

22. The vertiport management system of claim 21, wherein in determining the capacity for handling the air traffic at the vertiport, the vertiport manager operates to:
determine the capacity for handling the air traffic at the vertiport during a time period based on at least one of a historical resource availability at the vertiport, a historical resource usage at the vertiport, or a predicted demand for vertiport resources for the vertiport.

23. The vertiport management system of claim 21, wherein in determining a capacity at the vertiport, the vertiport manager operates to:
determine the capacity for handling the air traffic at the vertiport taking into account factors for the arrival slots, the departure slots, and the service slots.

24. The vertiport management system of claim 23, wherein the factors comprise at least one of a taxiing time, a boarding time, a disembarkation time, a gate occupancy time, a battery charging time, a safety check time, a turnaround time, a number of vehicles, a type of vehicle, a number of final approach and take off areas at the vertiport, a number of gates at the vertiport, a number of vehicles expected in a day, or a noise regulation.

25. The vertiport management system of claim 21, wherein in determining the capacity for handling the air traffic at the vertiport, the vertiport manager operates to:
determine occupancy times for a set of final approach and take off areas and a set of gates at the vertiport; and
determine the arrival slots, the departure slots, and the service slots available for use based on the occupancy times determined for the set of final approach and take off areas and the set of gates at the vertiport to form the capacity for handling the air traffic at the vertiport.

26. The vertiport management system of claim 25, wherein in determining the arrival slots, the departure slots, and the service slots available for use based on the occupancy times determined for the set of final approach and take off areas and the set of gates at the vertiport to form the capacity for handling the air traffic at the vertiport, the vertiport manager operates to:
determine the arrival slots, the departure slots, and the service slots available for use based on the occupancy times determined for the set of final approach and take off areas and the set of gates at the vertiport; and
decimate a portion of the arrival slots, the departure slots, and the service slots available for use to form a set of decimated slots that increase flexibility to accommodate when a set of unexpected events occur, wherein remaining arrival slots, remaining departure slots, and remaining service slots are the arrival slots, the departure slots, and the service slots available for use.

27. The vertiport management system of claim 25, wherein in determining the arrival slots, the departure slots, and the service slots available for use based on the occupancy times determined for the set of final approach and take off areas and the set of gates at the vertiport to form the capacity for handling the air traffic at the vertiport, the vertiport manager operates to:
determine the arrival slots, the departure slots, and the service slots available for use based on the occupancy times determined for the set of final approach and take off areas and the set of gates at the vertiport; and
add a buffer to at least one of the arrival slots, the departure slots, or the service slots.

28. The vertiport management system of claim 21, wherein in managing the allocation of the arrival slots, the departure slots, and the service slots for the air traffic using the vertiport based on the capacity determined for the vertiport, the vertiport manager operates to:
perform a reallocation of at least one of an arrival slot, a departure slot, or a service slot in response to a set of unexpected events that affect the capacity determined for the vertiport.

29. The vertiport management system of claim 28, wherein the reallocation is selected from at least one of reassigning the arrival slot; reassigning the departure slot; changing a duration of the arrival slot; changing a duration of the departure slot; changing a start time for an arrival slot; changing the start time for the departure slot; assigning an unassigned departure slot, assigning an unassigned arrival slot; reassigning an assigned service slot; and changing a duration of the assigned service slot, or assigning an unassigned gate.

30. The vertiport management system of claim 28, wherein the set of unexpected events that affect the capacity is selected from at least one of a flight delay of a flight using an allocated slot, a weather change, unexpected maintenance at the vertiport, an emergency request for the departure slot, the emergency request for the arrival slot, an unavailability of a final approach and take off area, or an unavailability of a gate.

31. The vertiport management system of claim 21, wherein in managing the allocation of the arrival slots, the departure slots, and the service slots for the air traffic using the vertiport based on the capacity determined for the vertiport, the vertiport manager operates to:
designate at least one of an arrival slot, a departure slot, and a service slot as reserved for use in managing the allocation of the arrival slots, the departure slots, or the service slots for the air traffic using the vertiport when a set of unexpected events occurs.

32. The vertiport management system of claim 21, wherein in managing the allocation of the arrival slots, the departure slots, and the service slots for the air traffic using the vertiport, the vertiport manager operates to:
receive a request to use the vertiport for a flight;
identify available arrival slots, available departure slots, and available service slots for meeting the request;
preallocate a set of the arrival slots, a set of the departure slots, and a set of the service slots from the available arrival slots, the available departure slots, and the available service slots for the request; and
allocate an arrival slot, a departure slot, and a service slot from preallocating the set of the arrival slots, a set of the departure slots, and a set of the service slots in response to the flight being confirmed.

33. The vertiport management system of claim 32, wherein the request to use the vertiport comprises an arrival time and duration for an arrival slot and a departure time and duration for a departure slot.

34. The vertiport management system of claim 32, wherein the request to use the vertiport comprises selection of an arrival slot and a departure slot from published arrival slots and published departure slots.

35.-38. (canceled)
